(19) United States
(12) Patent Application Publication
(10) Pub. No.: US 2026/0040261 A1
(43) Pub. Date: Feb. 5, 2026

(54) SYSTEM AND METHOD FOR UE LOCATION VERIFICATION IN NON-TERRESTRIAL NETWORK (NTN)

(71) Applicant: Apple Inc., Cupertino, CA (US)

(72) Inventors: Chunhai Yao, Beijing (CN); Chunxuan Ye, San Diego, CA (US); Dawei Zhang, Saratoga, CA (US); Wei Zeng, Saratoga, CA (US); Hong He, San Jose, CA (US); Haitong Sun, Saratoga, CA (US); Sigen Ye, San Diego, CA (US); Jie Cui, San Jose, CA (US); Weidong Yang, San Diego, CA (US); Oghenekome Oteri, San Diego, CA (US)

(21) Appl. No.: 18/997,028

(22) PCT Filed: Aug. 8, 2022
(86) PCT No.: PCT/CN2022/110845

§ 371 Date: Jan. 18, 2025

(51) Int. Cl. H04W 64/00; G01S 5/12; G01S 13/76; G01S 19/25; H04W 56/00; H04W 84/06

(52) U.S. Cl. CPC H04W 64/00; G01S 5/12; G01S 13/765; G01S 19/258; H04W 56/006; H04W 84/06

(57) ABSTRACT

The disclosure relates to system and method for UE location verification in non-terrestrial network (NTN). In some aspects, a base station (BS) may comprises at least one antenna, at least one radio configured to perform wireless communication using at least one radio access technology and one or more processors coupled to the at least one radio. The at least one radio and the one or more processors are configured to cause the BS to acquire, from a satellite in a Non-Terrestrial Network (NTN), an initial measurement between a user equipment (UE) and the satellite for determination of a location of the UE, acquire a compensation factor for compensating for a movement of the satellite to be used in determining the location of the UE, and provide the initial measurement and the compensation factor to a location server for calculation of the location of the UE.

### TECHNICAL FIELD

This application relates generally to wireless communication systems, including UE location verification in non-terrestrial network (NTN).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

In some cases, the wireless communication system may comprise one or more satellites which may relay signals or act as base stations, such as in non-terrestrial network (NTN). Typically, the coverage of a cell or a beam in NTN is much larger than the cell in the terrestrial networks. To locate the UE device in NTN may be beneficial.

### SUMMARY

In some aspects, a user equipment (UE) may comprise at least one antenna, at least one radio configured to perform wireless communication using at least one radio access technology, and one or more processors coupled to the at least one radio. The at least one radio and the one or more processors are configured to cause the UE to receive, from a network device in a Non-Terrestrial Network (NTN), a configuration for UE location report, determine that a condition for transmission of the UE location report is met, and transmit, to the network device, the UE location report which includes location information according to the configuration for the UE location report, upon determination that the condition is met.

In some aspects, a base station (BS) may comprise at least one antenna, at least one radio configured to perform wireless communication using at least one radio access technology and one or more processors coupled to the at least one radio. The at least one radio and the one or more processors are configured to cause the BS to acquire, from a satellite in a Non-Terrestrial Network (NTN), an initial measurement between a user equipment (UE) and the satellite for determination of a location of the UE, acquire a compensation factor for compensating for a movement of the satellite to be used in determining the location of the UE, and provide the initial measurement and the compensation factor to a location server for calculation of the location of the UE.

In some aspects, a user equipment (UE) may comprise at least one antenna, at least one radio configured to perform wireless communication using at least one radio access technology, and one or more processors coupled to the at least one radio. The at least one radio and the one or more processors are configured to cause the UE to receive, from a network device in a Non-Terrestrial Network (NTN), a configuration for a multi-round-trip time (multi-RTT) procedure for calculation of a location of the UE, wherein the configuration comprises a parameter which indicates a maximum permissible difference between a time when the UE receives a downlink positioning control signal and a time when the UE sends an uplink positioning control signal during performing the multi-RTT procedure; receive the downlink positioning control signal at a first time; and send the uplink positioning control signal within a time period indicated by the parameter from the first time.

In some aspects, a non-transitory computer readable memory medium storing program instructions executable by one or more processors to cause a user equipment (UE) to receive, from a network device in a Non-Terrestrial Network (NTN), a configuration for UE location report, determine that a condition for transmission of the UE location report is met, and transmit, to the network device, the UE location report which includes location information according to the configuration for the UE location report, upon determination that the condition is met.

In some aspects, a non-transitory computer readable memory medium storing program instructions executable by one or more processors to cause a base station to acquire, from a satellite in a Non-Terrestrial Network (NTN), an initial measurement between a user equipment (UE) and the satellite for determination of a location of the UE, acquire a compensation factor for compensating for a movement of the satellite to be used in determining the location of the UE, and provide the initial measurement and the compensation factor to a location server for calculation of the location of the UE.

In some aspects, a non-transitory computer readable memory medium storing program instructions executable by one or more processors to cause a user equipment (UE) device to receive, from a network device in a Non-Terrestrial Network (NTN), a configuration for a multi-round-trip time (multi-RTT) procedure for calculation of a location of the UE, wherein the configuration comprises a parameter which indicates a maximum difference between a time when the UE receives a downlink positioning control signal and a time when the UE sends an uplink positioning control signal during performing the multi-RTT procedure; receive the downlink positioning control signal at a first time; and send the uplink positioning control signal within a time period indicated by the parameter from the first time.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example architecture of an NTN communication system according to embodiments disclosed herein.

FIG. 4 is a signaling diagram for reporting location, by a UE device, according to embodiments disclosed herein.

FIG. 5 is a flowchart diagram for reporting location, by a UE device, according to embodiments disclosed herein.

FIG. 6 is a signaling diagram for facilitating the UE location verification, by a base station, according to embodiments disclosed herein.

FIGS. 7A and 7B are schematic diagram for a multi-round-trip time (multi-RTT) scheme, according to embodiments disclosed herein.

FIG. 8 is a schematic diagram for a multi-RTT scheme in NTN, according to embodiments disclosed herein.

FIGS. 9A and 9B are schematic diagram for a downlink-Time Difference of Arrival (DL-TDOA) scheme, according to embodiments disclosed herein.

FIG. 10 is a schematic diagram for a DL-TDOA scheme in NTN, according to embodiments disclosed herein.

FIGS. 11A and 11B are schematic diagram for an uplink-Time Difference of Arrival (UL-TDOA) scheme, according to embodiments disclosed herein.

FIG. 12 is a schematic diagram for a UL-TDOA scheme in NTN, according to embodiments disclosed herein.

FIG. 13 is a flowchart diagram for facilitating the UE location verification, by a base station, according to embodiments disclosed herein.

FIG. 14 is a signaling diagram for another multi-RTT scheme in NTN, according to embodiments disclosed herein.

FIG. 15 is a flowchart diagram for facilitating the UE location verification, by a UE device, according to embodiments disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

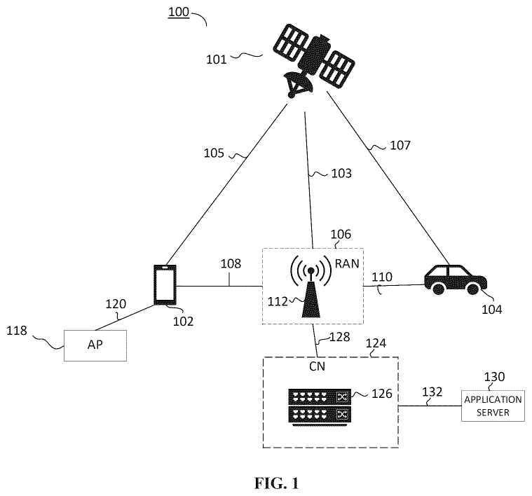

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IOT) device, or a machine type communications (MTC) device, among other examples, which may be implemented in various objects such as appliances, or vehicles, meters, among other examples. FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes a satellite 101, UE 102 and UE 104 (although any number of UEs may be used), and base station 112. In this example, the UE 102 is illustrated as smartphone (e.g., handheld touchscreen mobile computing devices connectable to one or more cellular networks) and the UE 104 is illustrated as a vehicle, but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers. In some embodiments, all or parts of the base station 112 may be implemented as one or more software entities running on server computers as part of a virtual network.

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 and a serving gateway (S-GW), and the S1-MME interface, which is a signaling interface between the base station 112 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 and a user plane function (UPF), and the S1 control plane (NG-C) interface, which is a signaling interface between the base station 112 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

In embodiments, the satellite 101 may communicate with base station 112 and UEs 102 and 104. Satellite 101 may be any suitable type of communication satellite configured to relay communications between different end nodes in a wireless communication system. Satellite 101 may be an example of a space satellite, a balloon, a dirigible, an airplane, a drone, an unmanned aerial vehicle, and/or the like. In some examples, the satellite 101 may be in a geosynchronous or geostationary earth orbit, a low earth orbit or a medium earth orbit. A satellite 101 may be a multi-beam satellite configured to provide service for multiple service beam coverage areas in a predefined geographical service area. The satellite 101 may be any distance away from the surface of the earth.

In embodiments, the satellite 101 may perform the functions of a base station 112, act as a bent-pipe satellite, or may act as a regenerative satellite, or a combination thereof. In other cases, satellite 112 may be an example of a smart satellite, or a satellite with intelligence. For example, a smart satellite may be configured to perform more functions than a regenerative satellite. A bent-pipe satellite may be configured to receive signals from ground stations and transmit those signals to different ground stations. A regenerative satellite may be configured to relay signals like the bent-pipe satellite, but may also use on-board processing to perform other functions. In the case of regenerative satellite, the satellite can be used as base station for the wireless communication.

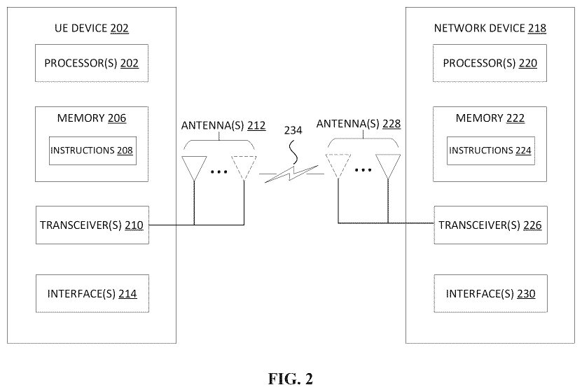

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a satellite or a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

FIG. 3 illustrates an example architecture of an NTN communication system according to embodiments disclosed herein.

The NTN communication system 300 may comprise a satellite 101, a UE device 102, a gNB 112 and multiple core networks, e.g., 301-303. The gNB 112 may incorporate a gateway or may be independent from a gateway (not shown).

The coverage of an NTN cell or a beam is typically much larger than the cell in the terrestrial networks. The coverage of one NTN cell may be across multiple countries. As shown in FIG. 3, one NTN cell covers three countries. Those skilled in the art would understand that this is just an exemplary example, and there may be more or fewer countries covered by one NTN cell.

The NTN network can broadcast multiple Public Land Mobile Networks (PLMNs) and multiple Type Allocation Codes (TACs) per PLMN, for example, up to a total of 12 TACs per PLMN, in one cell. The UE device 102 is not expected to perform a registration procedure, if one of the currently broadcast TACs belongs to the UE device's registration area.

A UE device 102 can report its coarse UE location information, e.g., coarse GNSS coordinates with accuracy around 2 km, to the NG-RAN, based on request from the network, after an Access Stratum (AS) security is established in connected mode. Those skilled in the art would understand that 2 km is just an example, and other accuracies may be possible, for example 5 km or 10 km, etc. The gNB 112 may perform an Authentication Management Function (AMF) selection based on the UE coarse location report, so as to select an appropriate core network from a plurality of core networks, e.g., 301-303. In a case where the NG-RAN node is configured to ensure that the selected AMF serves the country where the UE is located, the NG-RAN node takes into account UE location information, if available, when determining the AMF.

Thus, being able to locate the UE may be beneficial or even essential for NTN to support some services subject to national regulations or other operational constraints. Examples of such services may include Public Warning System, Charging and Billing, Emergency calls, Lawful Intercept, Data Retention Policy in cross-border scenarios and international regions, Network access, etc. To support such services, 3GPP networks should have the capability to locate each UE in a reliable manner and determine the policy that applies to their operation depending on their location and/or context.

In addition, to meet regulatory requirements, an NTN network may need to enforce that the selected PLMN is allowed to operate in the country of the UE location. This would require the network to verify the UE location during Mobility Management and Session Management procedures. That is to say, the network side would need to calculate the UE's location itself.

Before discussing the various aspects of calculating the UE's location by the network side, an embodiment of reporting location by the UE device will be firstly discussed.

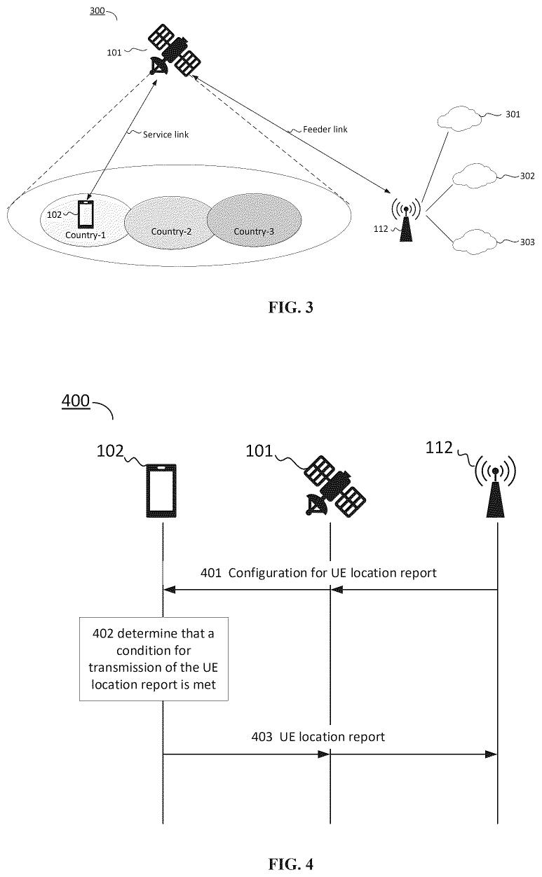

FIG. 4 is a signaling diagram for reporting location, by a UE device, according to embodiments disclosed herein.

The components involved in the procedure shown in FIG. 4 may comprise a UE 102, a satellite 101 and a gNB 112. FIG. 4 shows a scenario where the satellite 101 does not have an on-board gNB and the signaling involves the service link between the UE 102 and the satellite 101 and the feeder link between the satellite 101 and the gNB 112. Those skilled in the art would understand that the gNB 112 may be incorporated into the satellite 101 and thus the signaling may occur between the UE 102 and the satellite 101.

With reference to FIG. 4, at 401, the UE 102 receives a configuration for UE location report from the satellite 101. The configuration for UE location report may be received from the gNB 112.

The configuration for UE location report may comprise an indication of the necessity of UE location reporting. UE location reporting is not always necessary, depending on the regulatory and NTN coverage. For example, UE location reporting is not necessary when the NTN coverage is within a single country in case of a Geosynchronous Equatorial Orbit (GEO) satellite, when the NTN coverage is not large enough to have multiple PLMNs in case of a High Altitude Platform Station (HAPS) communication system, or when the NTN coverage is not large enough to have multiple AMFs.

According to one aspect, the indication of the necessity of UE location reporting may be communicated via a System Information Block (SIB). The SIB may be SIBI or SIB19. For example, SIB 19 has a field of “Location-Report” with value of enabling and/or disabling. This field may be changed to indicate whether to report the UE location. The change of this field may trigger a System Information (S1) modification procedure, which means that all UEs which have registered with the current cell will update their SIB, and thus will change the action regarding the UE location reporting according to the modified SIB in real time. Alternatively, the change of this field may not trigger the SI modification procedure, like other parameters, e.g., ephemeris, etc., in SIB19, which means that the UEs which have registered with the current cell will not update their SIB, but new UEs which may move into the cell at a later time will receive the modified SIB and perform the action regarding the UE location reporting according to the modified SIB.

According to another aspect, the indication of the necessity of UE location reporting may be communicated via a handover command. For example, a field of “Location-Report” may be included in the handover command during the handover of the cell.

According to yet another aspect, the indication of the necessity of UE location reporting may be communicated via a dedicated Radio Resource Control (RRC) message. For example, UE may report its coarse location when in country 1, and then the UE moves to country 2. At this time, a dedicated RRC message may be triggered to communicate whether to need the UE location reporting.

In addition to the indication of the necessity of UE location reporting, the configuration for UE location report may comprise a threshold for the UE device to trigger the UE location report or an indication for the UE device to report its location with a periodicity. Details will be discussed with reference to step 402 below.

At 402, the UE 102 determines that a condition for transmission of the UE location report is met.

According to one aspect, determining that the condition for transmission of the UE location report is met may comprise receiving a request requiring the UE device 102 to transmit the UE location report. In other words, it's the network which triggers the UE location reporting. UE location reporting by triggering may be referred to as event-based or aperiodic-based UE location reporting.

In one example, the network side may trigger the UE location reporting. For example, when the NTN's coverage moves to a new coverage location, e.g., a new country, or a new PLMN, etc., the network side may send a request to the UE device 102 to indicate that UE needs to report its coarse location. The request may be transmitted via a Media Access Control (MAC) Control Element (CE), a dedicated RRC message, or a common RRC message.

In another example, the UE device 102 may trigger UE location reporting. For example, when the change in location of the UE device 102, i.e., difference between current location and last reported location, is larger than a threshold, then the UE device 102 may trigger UE location reporting. The threshold may be configured by network via the configuration for UE location report received from the network side at 401. In this example, determining that the condition for transmission of the UE location report is met may comprise detecting that the UE device's location change representing a difference between the UE device's current location and a last reported location is equal to or larger than the threshold.

According to another aspect, the UE location reporting may be periodicity-based. The network side may request the UE device to periodically report its coarse location. In this case, the configuration for UE location report signaled at 401 may include an indication for the UE device to report its location with a periodicity. In this aspect, determining that the condition for transmission of the UE location report is met at 402 may comprise determining a timing for transmission of the UE location report meets the periodicity. In order to realize the periodic UE location reporting, a “location-reporting Scheduling Request (SR)” may be configured. Specifically, the UE device 102 triggers the SR to the network side with a periodicity and send the location report upon receiving a UL grant from the network side.

At 403, the UE device 102 transmits, to the network side, the UE location report including the UE device's location information, upon determination that the condition is met. The UE location report is transmitted via either a MAC CE, or a dedicated RRC message. For the case of reporting via a MAC CE, either a new MAC CE or modified existing MAC CE, e.g., “Timing Advance Report MAC CE”, may be used.

The location report may be in a format of two-dimensional coordinates (X, Y) in an Earth-Centered, Earth-Fixed (ECEF) coordinate system. The bit length of X or Y may be dependent on the accuracy requirement of the UE device's location report which may depends on the regulatory requirement. For example, more bits are allocated for X or Y for a coarse location reporting, and less bits are allocated for X or Y for a fine location reporting. Alternatively, the bit length of X or Y may be independent on the regulatory requirement. For example, in case of coarse location reporting, some bits are ignored.

The bit length of X or Y may be signaled via a SIB, e.g., SIB19, or via a dedicated RRC message. The signaling may be an explicit signaling the bit length of X or Y, or an implicit signaling the bit length of X or Y, based on the accuracy requirement of UE location reporting, e.g., 2 km or 10 km.

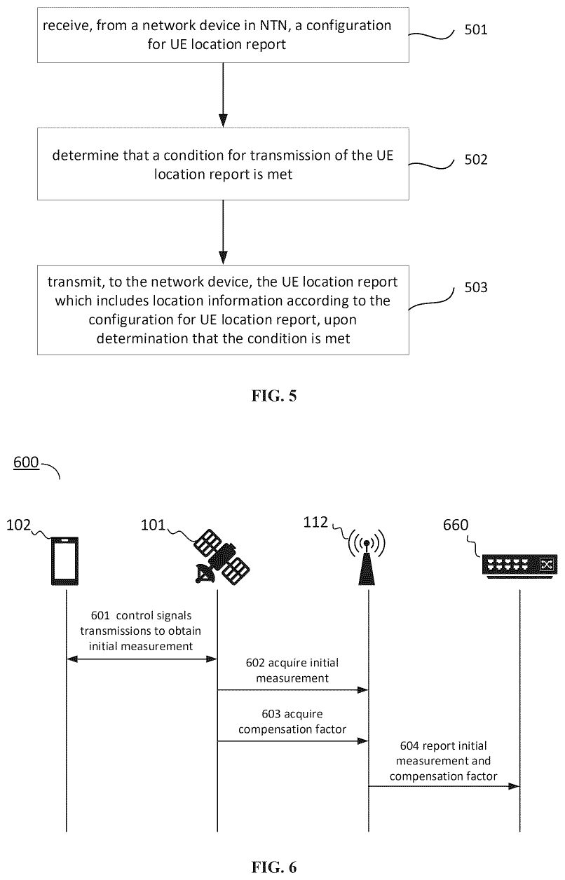

FIG. 5 is a flowchart diagram for reporting location, by a UE device, according to embodiments disclosed herein.

At 501, the UE device receives, from a network device in NTN, a configuration for UE location report.

At 502, the UE device determines that a condition for transmission of the UE location report is met.

At 503, the UE device transmits, to the network device, the UE location report including location information according to the configuration for UE location report, upon determination that the condition is met.

The details on the configuration for UE location report, the condition for transmitting the UE location report and the UE location reporting may be same as those discussed with reference to FIG. 4 above.

Next, the various aspects of calculating the UE's location or facilitating the calculation of the UE's location will be discussed with reference to FIGS. 6 to 15.

FIG. 6 is a signaling diagram for facilitating the UE location verification, by a base station, according to embodiments disclosed herein.

The components involved in the procedure shown in FIG. 6 may comprise a UE 102, a satellite 101, a gNB 112 and a Location Management Function (LMF) 660 residing on a location server. Again, FIG. 6 shows a scenario where the satellite 101 does not have an on-board gNB and the signaling includes at least the service link between the UE 102 and the satellite 101 and the feeder link between the satellite 101 and the gNB 112. Those skilled in the art would understand that the gNB 112 may be incorporated into the satellite 101 and thus the signaling may be adjusted accordingly.

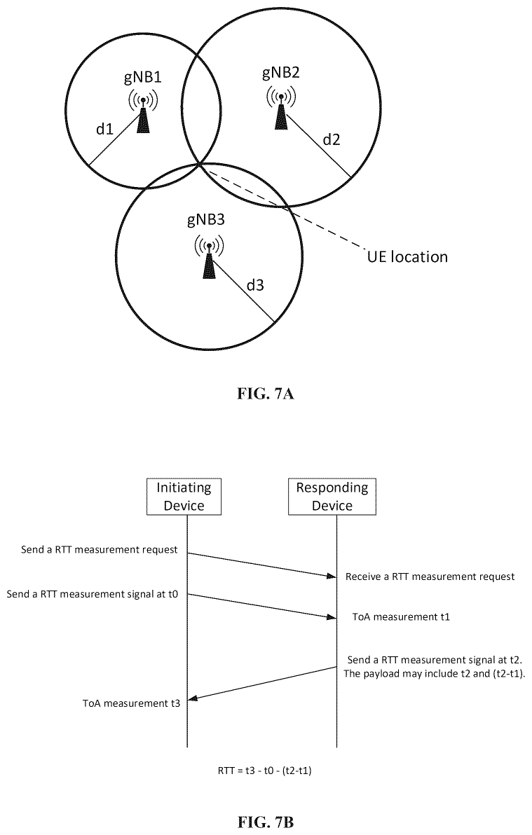

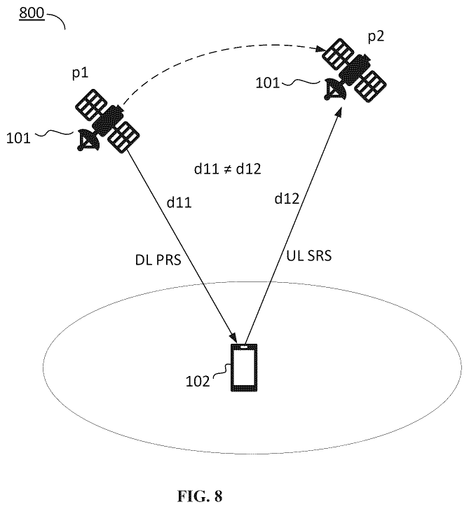

At 601, the UE 102 and the satellite 101 perform control signal interactions to obtain an initial measurement. The control signals may comprise a downlink positioning control signal and an uplink positioning control signal, e.g., positioning reference signal (PRS) and Sounding Reference signal (SRS). The initial measurement may comprise measurements according to a multi-round-trip time (multi-RTT) scheme, a downlink-Time Difference of Arrival (DL-TDOA) scheme or an uplink-Time Difference of Arrival (UL-TDOA) scheme, etc. Example embodiments of the control signals and initial measurement will be discussed with reference to FIGS. 7A to 15.

At 602, the gNB 112 acquires, from the satellite 101, the initial measurement.

At 603, the gNB 112 acquires a compensation factor for compensating for a movement of the satellite to be used in determining the location of the UE device. The gNB 112 may acquire the compensation factor from the satellite or from another entity. The traditional schemes of determining a UE's location, e.g., multi-RTT, DL-TDOA or UL-TDOA involves a stationary BS or multiple stationary BSs. When the UE's location measurement is performed using any of such schemes in case of using a satellite in place of a stationary BS, the movement of the satellite needs to be considered. Different compensation factors for compensating for a movement of the satellite are adopted with respect to different UE location calculation schemes. Example embodiments of the compensation factor will be discussed with reference to FIGS. 7A to 13.

At 603, the gNB 112 provides the initial measurement and the compensation factor to the LMF 660 for calculating the location of the UE device.

FIGS. 7A and 7B are schematic diagram for a multi-RTT scheme, according to embodiments disclosed herein.

As shown in FIG. 7A, a UE′ location can be determined by using at least three BSs. The distance, d1, d2 or d3, from each BS (gNB1, gNB2, and gNB3) to the target UE can be first determined, and then the UE′ location can be determined as the intersection position of the three circles with the radii d1, d2 and d3, respectively. The distance, d1, d2 or d3, from each BS (gNB1, gNB2, and gNB3) to the target UE may be determined by using a RTT measurement between the respective BS and the UE, as shown in FIG. 7B.

With reference to 7B, the RTT measurement may be obtained via multiple signaling interactions between an initiating device and a responding device. The initiating device may be a gNB or a UE, and the responding device may be a UE and a gNB, respectively.

The measurement procedure may comprise three or four signalings. At a first step, the initiating device (say gNB) sends a control signal to UE to indicate that one or more gNBs would be transmitting RTT measurement signal in DL. At a second step, the gNB sends a RTT measurement signal at t0. The UE then measures the time of arrival (TOAs) t1 relative to its own timing. At a third step, the UE then sends a UL RTT measurement signal at t2. The payload of this UL signal may include t2 and (t2-t1). The gNB then measures the time of arrival (TOAs) t3. Alternatively, the (t2-t1) may be transmitted in a separate signal from the t2.

The RTT may then be computed from the arrival time of the UL signal (t3), combined with the UE timing information provided in the payload (t2-t1). To be specific, the RTT from this gNB to the UE would be:

$$RTT = t 3 - t 0 - ( t 2 - t 1 ) \qquad Equation ( 1 )$$

Likewise, all gNBs in the neighborhood also measure precisely the observed TOAs and extract the UE TOA measurement payload (t2-t1).

Then the distance d_i from the UE to i-th gNB can be computed from the respective RTT_i. Finally, a multilateration method may be applied to determine the location of the UE.

Regarding the signalings in the multi-RTT scheme, according to an example, the UE may measure the UE Rx-Tx time difference measurements and optionally DL-PRS-Reference Singal Receiving Power (RSRP) of the received signals using assistance data received from the positioning (location) server, and the Transmission Reception Points (TRPs) measure the gNB Rx-Tx time difference measurements and optionally UL-SRS-RSRP of the received signals using assistance data received from the positioning server. The measurements are used to determine the RTT at the positioning server which are used to estimate the location of the UE.

FIG. 8 is a schematic diagram for a multi-RTT scheme in NTN, according to embodiments disclosed herein.

In NTN, the determination of the UE location may be performed by using the satellite at three or more positions to simulate the multiple BSs. However, since the satellite moves between its initial transmission of DL-PRS and its reception of UL-SRS, e.g., the satellite 101 is located at position p1 when transmitting the DL-PRS and moves to position p2 when receiving UL-SRS as shown in FIG. 8, the distance d11 between the satellite at p1 and the UE is not equal to d12 between the satellite at p2 and the UE. A compensation factors for compensating for a movement of the satellite can be applied to correct this deviation.

According to one aspect, the gNB may report the satellite location to LMF to facilitates LMF's calculation of UE location.

In one example, the satellite location may comprise the satellite ephemeris information together with epoch time information, and the time the satellite transmits the DL-PRS and the time the satellite receives UL-SRS. The satellite ephemeris information may be either in orbital format or position and velocity state vector format.

In another example, the satellite location may comprise exact location of the satellite location when sending DL-PRS and when receiving UL-SRS. The exact location may be either in Earth-centered, Earth-fixed coordinate system (ECEF) or in Earth Centered Inertial (ECI).

Note that this may not apply to Geosynchronous Earth Orbit (GEO) satellite since the GEO satellite is stationary relative to the earth.

LMF may then determine the UE location based on the RTT measurements and the satellite locations when transmitting a DL-PRS and when receiving a UL-SRS reported from the gNB.

In addition, the gNB may report the UE's Timing Advance (TA) report to LMF to facilitates LMF's calculation of UE location. In this case, the gNB may modify the threshold of the UE's TA report triggering to match the UE location verification feature. In other words, the gNB may modify a threshold for triggering the UE device's TA reporting according to enablement or disablement of the calculating the location of the UE device. For example, one threshold is for UE's TA reporting with the enablement of UE location verification feature, and another threshold is for UE's TA reporting with the disablement of UE location verification feature.

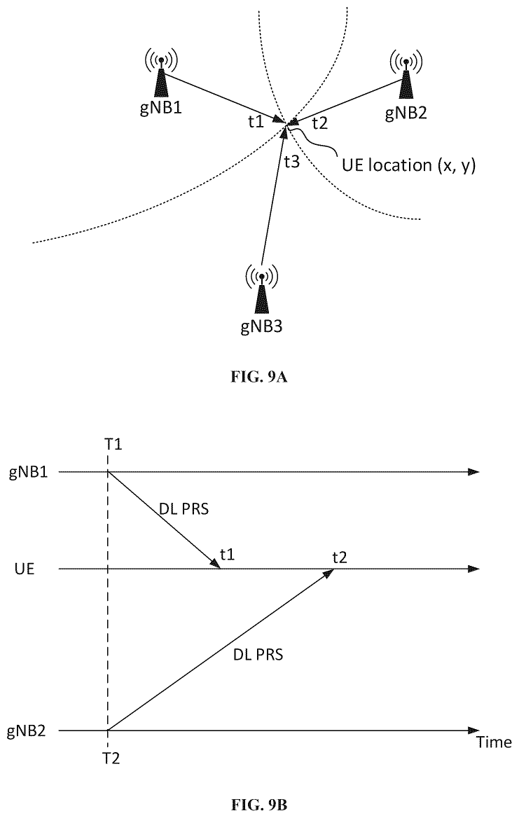

FIGS. 9A and 9B are schematic diagram for a downlink-Time Difference of Arrival (DL-TDOA) scheme, according to embodiments disclosed herein.

As shown in FIG. 9A, a UE′ location can be determined by using at least three BSs. Mutiple gNBs/TRPs transmit reference signals for positioning purpose, e.g., PRS. As shown in FIG. 9B, the gNB 1 transmits DL PRS at timing T1 and the gNB2 transmits DL PRS at timing T2 which is equal to T1. The UE makes TOA measurements (t1, t2) of the reference signals received from multiple gNBs.

$${t}_{1} = {T}_{1} + \frac{\sqrt{{( {x}_{1} − x )}^{2} + {( {y}_{1} − y )}^{2}}}{c} \qquad Equation ( 2 )$$

$$\begin{matrix} & {t}_{2} = {T}_{2} + \frac{\sqrt{{( {x}_{2} − x )}^{2} + {( {y}_{2} − y )}^{2}}}{c}\end{matrix} \qquad Equation ( 3 )$$

wherein (x1, y1) is the position coordinate of gNB1, and (x2, y2) is the position coordinate of gNB2, (x, y) is the position coordinate of the target UE, c is the velocity of light, T₁ and T2 are the timings when the gNB1 and gNB2 transmit the reference signal, respectively, and t1 and t2 are the timings when the UE receives the reference signals from the gNB1 and gNB2, respectively,

The UE then calculates TDOAs (t2-t1) of the reference signal from each gNB by subtracting the TOA of a reference gNB (say gNB1) from the observed TOA of the reference signal from each gNB. Geometrically, the received signal time difference (RSTD) (t2-t1) with respect to two gNBs determines a hyperbola between the two gNBs, according to the Equations (2) and (3). Two hyperbolas may be determined via three gNBs. A point where these hyperbola intersect is the desired UE location (x,y).

Note that a very good synchronization among gNBs/TRPs is required for the DL-TDOA scheme.

According to an example, the DL-TDOA positioning method may make use of the DL RSTD and optionally DL-PRS-RSRP of downlink signals received from multiple Transmission Points (TPs) at the UE. The UE may measure the DL RSTD and optionally DL-PRS-RSRP of the received signals using assistance data received from the positioning/location server, and the resulting measurements are used along with other configuration information to locate the UE in relation to the neighboring TPs.

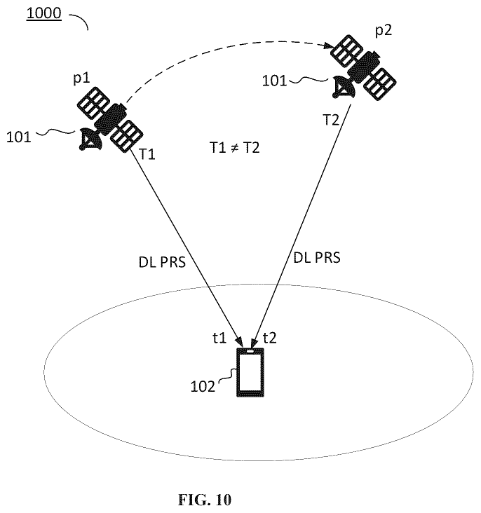

FIG. 10 is a schematic diagram for a DL-TDOA scheme in NTN, according to embodiments disclosed herein.

In NTN, the determination of the UE location may be performed by using the satellite at three or more positions to simulate the multiple BSs. In this case, the single satellite transmits multiple DL-PRSs at different timings. In other words, T1/T2, as shown in FIG. 10. A compensation factors for compensating for a movement of the satellite can be applied to correct this deviation.

According to one aspect, the gNB may report the timing difference between two neighbor DL-PRS transmissions to LMF to facilitate the calculation of UE location.

In one example, the gNB may report both T1 and T2 to LMF. In another example, the gNB may report (T2-T1) directly.

Note that this may not apply to GEO satellite since the GEO satellite is stationary relative to the earth.

In addition, the gNB may also report the satellite location when transmitting each DL-PRS to LMF to facilitates LMF's calculation of UE location. The location information may be similar to that depicted with reference to the multi-RTT scheme. For example, the satellite location may comprise the satellite ephemeris information together with epoch time information, and the time the satellite transmits the DL-PRS. The satellite ephemeris information may be either in orbital format or position and velocity state vector format. Alternatively, the satellite location may comprise exact location of the satellite location when sending DL-PRS either in ECEF or in ECI.

LMF may then determine the UE location based on the initial DL-TDOA measurements and at least the timing difference between two neighbor DL-PRS transmissions reported from the gNB.

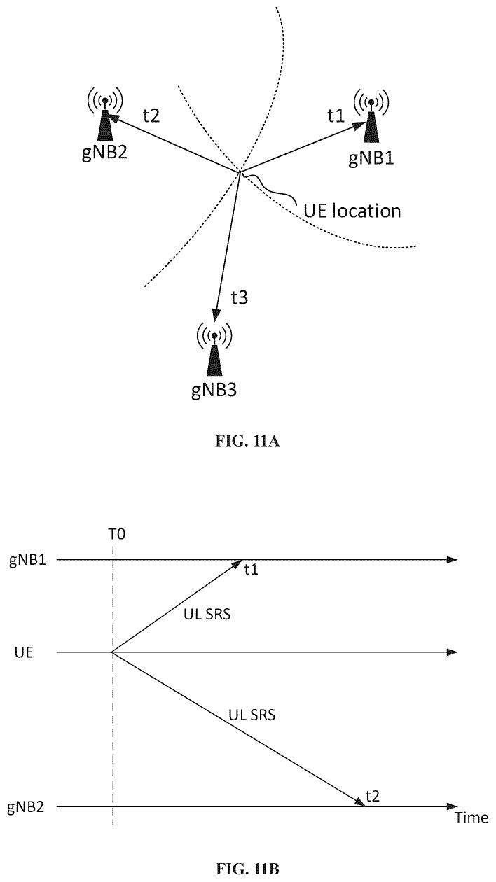

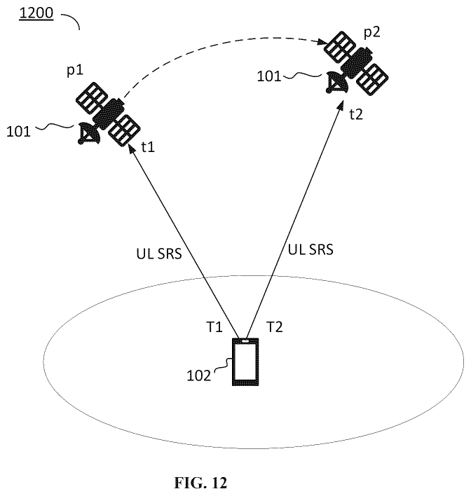

FIGS. 11A and 11B are schematic diagram for an uplink-Time Difference of Arrival (UL-TDOA) scheme, according to embodiments disclosed herein.

As shown in FIGS. 11A and 11B, a UE′ location can be determined by using at least three BSs. The UL-TDOA scheme is similar to the DL-TDOA depicted with reference to FIGS. 9A and 9B. Specifically, UE may transmit an SRS to multiple gNBs including gNB1, gNB2 and gNB3 at TO. Each gNB receiving the SRS may measure a TOA, e.g., t1 and t2, respectively. A gNB (say gNB2) may calculate a UL Relative Time of Arrival (RTOA) by subtracting the TOA measured at reference gNB (gNB1) from the TOA of gNB2.

As shown in FIG. 11B, the UE transmits a PRS to gNB1 and gNB2 at TO. The gNB1 measures the TOA (t1) of PRS and the gNB2 measures the TOA (t2) of PRS.

$${t}_{1} = {T}_{0} + \frac{\sqrt{{( {x}_{1} − x )}^{2} + {( {y}_{1} − y )}^{2}}}{c} \qquad Equation ( 4 )$$

$${t}_{2} = {T}_{0} + \frac{\sqrt{{( {x}_{2} − x )}^{2} + {( {y}_{2} − y )}^{2}}}{c} \qquad Equation ( 5 )$$

wherein (X1, y1) is the position coordinate of gNB1, and (x2, y2) is the position coordinate of gNB2, (x, y) is the position coordinate of the target UE, c is the velocity of light, To is the timing when the UE transmits the reference signal PRS, and t1 and t2 are the timings when the gNB1 and the gNB2 receive the PRS, respectively.

The gNB2 then calculates a UL RTOA (t2-t1) by subtracting the TOA measured at reference gNB (gNB1) from the TOA of gNB2. Geometrically, the RTOA between two gNBs determines a hyperbola between the two gNBs, according to the Equations (2) and (3). A point where these hyperbola intersect is the desired UE location (x,y).

According to an example, the UL-TDOA positioning method makes use of the UL-RTOA and optionally UL-SRS-RSRP at multiple Reception Points (RPs) of uplink signals transmitted from the UE. The RPs measure the UL-RTOA and optionally UL-SRS-RSRP of the received signals using assistance data received from the positioning/location server, and the resulting measurements are used along with other configuration information to estimate the location of the UE.

FIG. 12 is a schematic diagram for a UL-TDOA scheme in NTN, according to embodiments disclosed herein.

In NTN, the determination of the UE location may be performed by using the satellite at three or more positions to simulate the multiple BSs. In this case, the UE transmits multiple UL-SRSs at different timings, e.g., at T1 and T2, respectively, as shown in FIG. 10. A compensation factors for compensating for a movement of the satellite can be applied to correct this deviation.

According to one aspect, the UE may report the timing difference between two consecutive UL-SRS transmissions to the serving gNB via the satellite and the gNB reports it to LMF to facilitate the calculation of UE location.

In one example, the UE and thus the gNB may report both T1 and T2 to LMF. In another example, the UE and thus the gNB may report (T2-T1) directly. The timing advance (TA) value used in the UL-SRS transmissions may also be reported by the UE.

Note that this may not apply to GEO satellite since the GEO satellite is stationary relative to the earth.

In addition, the gNB may also report the satellite location when receiving each UL-SRS to LMF to facilitates LMF's calculation of UE location. The location information may be similar to that depicted with reference to the multi-RTT scheme. For example, the satellite location may comprise the satellite ephemeris information together with epoch time information, and the time the satellite receives the UL-SRS. The satellite ephemeris information may be either in orbital format or position and velocity state vector format. Alternatively, the satellite location may comprise exact location of the satellite location when receiving a UL-SRS either in ECEF or in ECI.

LMF may then determine the UE location based on the initial UL-TDOA measurements and at least the timing difference between two consecutive UL-SRS transmissions reported from the gNB.

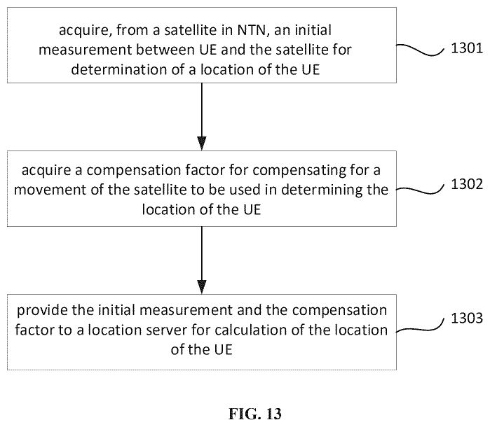

FIG. 13 is a flowchart diagram for facilitating the UE location verification, by a base station, according to embodiments disclosed herein.

At 1301, the gNB acquires, from a satellite in NTN, an initial measurement between a UE device and the satellite for determination of a location of the UE device.

At 1302, the gNB acquires a compensation factor for compensating for a movement of the satellite to be used in determining the location of the UE device.

At 1303, the gNB provides the initial measurement and the compensation factor to a location server for calculation of the location of the UE device.

The various illustrative examples of the initial measurement and the compensation factor have been discussed with reference to FIGS. 7A to 12 above, and thus the details are omitted for avoiding repetition.

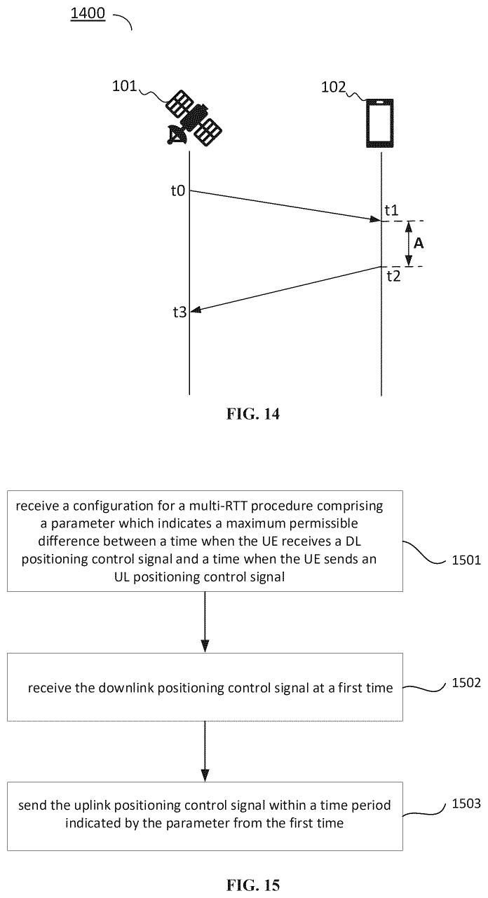

FIG. 14 is a signaling diagram for another multi-RTT scheme in NTN, according to embodiments disclosed herein.

The signaling diagram 1400 may be used in combination with the multi-RTT scheme depicted with reference to FIGS. 7A and 7B.

As discussed above, in NTN, when adopting the multi-RTT scheme, the determination of the UE location may be performed by using the satellite at three or more positions to simulate the multiple gNBs. However, since the satellite moves between its initial transmission of DL-PRS and its reception of UL-SRS, the distance between the satellite at its initial transmission of DL-PRS and the UE is not equal to the distance between the satellite at its reception of UL-SRS and the UE. A deviation may occur. A method of using a compensation factor for compensating for a movement of the satellite to correct such deviation has been depicted with reference to FIG. 8. Here, another method to correct or avoid such deviation is discussed with reference to FIG. 14.

According to one aspect, the gNB or LMF may schedule short enough time gap between UE receiving DL-PRS (t1) and UE sending UL-SRS (t2). The short time gap may ensure that the satellite does not move too far away during the multi-RTT procedure.

The UE may receive, from a network device in NTN, a configuration for a multi-RTT procedure for the UE device's location calculation. The configuration may comprise a parameter A which indicates a maximum permissible difference between a time when the UE receives DL-PRS and a time when the UE sends UL-SRS during performing the multi-RTT procedure. The parameter may be provided via a SIB or a dedicated RRC message.

UE is not expected to send UL-SRS which is A milli-seconds after receiving DL-PRS, according to the configuration.

The value of the parameter A may depend on the accuracy requirement of the UE positioning calculation/verification. For example, the value of A may be larger for a coarser accuracy (e.g., 10 km), and the value of A may be smaller for finer accuracy (e.g., 2 km).

Additionally or alternatively, the value of the parameter A may depend on UE location or UE specific Koffset. In this case, the gNB may report UE specific Koffset and/or cell specific K_{offset} to LMF to facilitate LMF to calculate the gap between UE's reception of DL-PRS and UE's sending of UL-SRS.

FIG. 15 is a flowchart diagram for facilitating the UE location verification, by a UE device, according to embodiments disclosed herein.

At 1501, the UE receives, from a network device in NTN, a configuration for a multi-RTT procedure for calculation of a location of the UE device. The configuration may comprise a parameter which indicates a maximum permissible difference between a time when the UE device receives a downlink positioning control signal and a time when the UE device sends an uplink positioning control signal during performing the multi-RTT procedure.

At 1502, the UE receives the downlink positioning control signal at a first time.

At 1503, the UE sends the uplink positioning control signal within a time period indicated by the parameter from the first time.

Embodiments contemplated herein include one or more non-transitory computer-readable media comprising instructions to cause an electronic device, upon execution of the instructions by one or more processors of the electronic device, to perform one or more elements of the methods as above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the methods as above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the methods as above. This apparatus may be, for example, an apparatus of a UE (such as a wireless device 202 that is a UE, as described herein).

Embodiments contemplated herein include a signal as described in or related to one or more elements of the methods as above.

Embodiments contemplated herein include a computer program or computer program product comprising instructions, wherein execution of the program by a processor is to cause the processor to carry out one or more elements of the methods as above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio, configured to perform wireless communication using at least one radio access technology; and
one or more processors coupled to the at least one radio, wherein the at least one radio and the one or more processors are configured to cause the UE to:
receive, from a network device in a Non-Terrestrial Network (NTN), a configuration for a UE location report;
determine that a condition for transmission of the UE location report is met; and
transmit, to the network device, the UE location report which includes location information according to the configuration for the UE location report, upon determination that the condition is met.

2-5. (canceled)

6. The UE according to claim 1, wherein the configuration for UE location report includes a threshold for the UE to trigger the UE location report, and
wherein the UE configured to determine that the condition for transmission of the UE location report is met is further configured to detect that a location change of the UE representing a difference between a current location of the UE and a last reported location of the UE is greater than or equal to the threshold.

7-8. (canceled)

9. The UE according to claim 1, wherein the UE location information comprises two-dimensional coordinates in an Earth-Centered, Earth-Fixed (ECEF) coordinate system.

10. The UE according to claim 9, wherein bit lengths of the two-dimensional coordinates are variable dependent on an accuracy requirement of the UE location report, or
wherein the bit lengths of the two-dimensional coordinates are independent on the accuracy requirement of the UE location report.

11. (canceled)

12. A base station (BS), comprising:
at least one antenna;
at least one radio, configured to perform wireless communication using at least one radio access technology; and
one or more processors coupled to the at least one radio, wherein the at least one radio and the one or more processors are configured to cause the BS to:
acquire, from a satellite in a Non-Terrestrial Network (NTN), an initial measurement between a user equipment (UE) and the satellite for determination of a location of the UE;
acquire a compensation factor for compensating for a movement of the satellite to be used in determining the location of the UE; and
provide the initial measurement and the compensation factor to a location server for calculation of the location of the UE, wherein satellite ephemeris information and epoch time information at the time of the initial measurement are provided to the location server.

13. The BS according to claim 12, wherein the initial measurement comprises at least three sets of round-trip time (RTT) measurements according to a multi-RTT scheme, each set of RTT measurements are associated with a respective first location of the satellite when the satellite sends a downlink positioning control signal and a s respective second location of the satellite when the satellite receives an uplink positioning control signal, and
wherein the compensation factor comprises information on the respective first location and the respective second location of the satellite associated with each of the at least three sets of RTT measurements.

14. The BS according to claim 13, wherein the information on the respective first location and the respective second location of the satellite comprises one of:
coordinate values of the first location and the second location in an Earth-Centered, Earth-Fixed (ECEF) coordinate system or in an Earth Centered Inertial (ECI) coordinate system.

15. The BS according to claim 13, wherein the compensation factor further comprises a Timing Advance (TA) of the UE.

16. The BS according to claim 15, wherein the at least one radio and the one or more processors are further configured to cause the BS to modify a threshold for triggering a report of the TA of the UE according to an enablement or disablement of the calculation of the location of the UE.

17. The BS according to claim 12, wherein the initial measurement comprises at least two Time Difference of Arrival (TDOA) measurements according to a downlink-TDOA (DL-TDOA) scheme, each TDOA measurement is associated with two consecutive downlink positioning control signal transmissions at two different timings from the satellite to the UE, and
wherein the compensation factor comprises information on the two timings.

18. The BS according to claim 17, wherein the information on the two timings comprises one of:
the two timings, or
a difference between the two timings.

19. The BS according to claim 17, wherein the compensation factor further comprises information on a location of the satellite when the satellite sends each downlink positioning control signal transmission.

20. The BS according to claim 12, wherein the initial measurement comprises at least two Time Difference of Arrival (TDOA) measurements according to an uplink-TDOA (UL-TDOA) scheme, each TDOA measurement is associated with two consecutive uplink positioning control signal transmissions at two different timings from the UE to the satellite, and
wherein the compensation factor comprises information on the two timings.

21. The BS according to claim 20, wherein the information on the two timings comprises one of:
the two timings, or
a difference between the two timings.

22. The BS according to claim 20, wherein the compensation factor further comprises information on a location of the satellite when the satellite receives each uplink positioning control signal transmission.

23. The BS according to claim 22, wherein the compensation factor further comprises a Timing Advance (TA) of the UE used in each uplink positioning control signal transmission.

24. A user equipment (UE), comprising:
at least one antenna;
at least one radio, configured to perform wireless communication using at least one radio access technology; and
one or more processors coupled to the at least one radio, wherein the at least one radio and the one or more processors are configured to cause the UE to:
receive, from a network device in a Non-Terrestrial Network (NTN), a configuration for a multi-round-trip time (multi-RTT) procedure for calculation of a location of the UE, wherein the configuration comprises a parameter which indicates a maximum permissible difference between a time when the UE receives a downlink positioning control signal and a time when the UE sends an uplink positioning control signal during performing the multi-RTT procedure;
receive the downlink positioning control signal at a first time; and
send the uplink positioning control signal within a time period indicated by the parameter from the first time.

25. The UE according to claim 24, wherein the parameter is provided via a System Information Block (SIB) or a dedicated Radio Resource Control (RRC) message.

26. The UE according to claim 24, wherein the parameter is variable dependent on an accuracy requirement of the calculation of the location of the UE.

27. The UE according to claim 24, wherein the parameter is variable dependent on the location of the UE or a Kofizet specific to the UE.

28-30. (canceled)
